(19) United States
(12) Patent Application Publication
(10) Pub. No.: US 2011/0037280 A1
(43) Pub. Date: Feb. 17, 2011

(54) Pet waste handling system

(76) Inventor: Melanie Romero, Aurora, CO (US)

Correspondence Address: Melanie Romero, 6850 S. Harvest Ct., Aurora, CO, 80016, US

(21) Appl. No.: 12/583,236

(22) Filed: Aug. 17, 2009

(51) Int. Cl. A01K 29/00

(52) U.S. Cl. 294/1.4

(57) ABSTRACT

A pet waste handling system that can be used on a variety of yard surfaces is disclosed. The system comprises a gathering tool and a bagging tool that can be used in combination to gather, store, and dispose of pet wastes or other yard debris. A user grasps one tool in each hand and uses the gathering tool to whisk or scrape the debris into the bag attached to the bagging tool. The gathering tool has a handle and a gathering head which can be triangular and has a number of stiff fingers. The bagging tool has a handle and a frame head for supporting and holding a flexible bag. In one embodiment, the frame is generally triangle-shaped. The frame is pressed against the yard surface and positioned to receive the pet wastes from the gathering tool.

### TECHNICAL FIELD

This invention relates generally to the field of pet and yard products and, more particularly, to an improved pet waste handling system.

### BACKGROUND

There are many responsibilities and tasks associated with having and caring for a pet. One of the more onerous of such tasks is the handling and disposal of pet wastes. Commonly, a pet is taught to use a lawn or other similar outdoor area on which to deposit wastes. Although this arrangement can be advantageous over other options, the pet owner is left with the job of periodically removing the wastes from the yard.

There are many devices available to the pet owner that can assist in handling and removing pet wastes from a yard or outdoor area. Generally, the existing devices can be classified into one of two groups: rakes or scrapers.

Rakes are a subset of hand tools usually comprising a handle and a rake head. A standard rake head has a main body which extends perpendicularly from a handle. Extending generally downward from the main body of the rake head are a number of tines. The tines are positioned so that they form a ninety degree angle with the handle. The tines also form a separate ninety degree angle with the main body of the rake head. The tines act like a comb, allowing the rake head to pass through grass or other yard materials (such as landscaping gravel, mulch, etc.) while grabbing and dislodging pet waste therefrom. However, rake tines tend to be flexible and can bend under pressure resulting in a sharp springing motion when that pressure is released (consider a common leaf rake, for example). When the tines spring back into position they can fling any gathered pet waste causing the waste to be scattered and/or impacted onto the rake head. Another significant failure inherent in current rakes is that they can not be used as a scraper on hard surfaces: the flexible tines can partially pass through the pet waste, or they can fail to dislodge the waste completely from the surface.

Assuming a rake is somewhat successful in gathering pet waste, it can be difficult to dislodge the gathered waste from the rake in order to place the waste in a trash bag or other receptacle: either the waste is impacted between and/or on the rake tines, or it is loose and has to be balanced in the angle formed between the tines and the main body of the rake head, resulting in the user performing a “balancing act” while maneuvering the waste into a receptacle. Alternatively, a separate “dust-pan” tool can be used to receive the waste from the rake. This solution is inefficient for a number of reasons (e.g., it necessitates the cleaning of a second tool).

Scrapers were developed to address the inadequacies of rakes for removing pet waste from hard surfaces. They are a subset of hand tools usually comprising a handle and a scraper head. A standard scraper head extends perpendicularly from a handle and has a straight or concave surface or blade extending downwards from the main body of the head. The blade forms a ninety degree angle with the handle. The blade terminates in a straight edge. The edge is designed to scrape pet waste off of hard surfaces, and the blade allows it to be gathered together for disposal. Although functional on hard surfaces, since the scraper has no tines, it has difficulty separating pet waste from yard materials. For example, scrapers work quite well on concrete or other hard, flat surfaces, but generally fail when they are used in an attempt to separate pet waste from long grass, mulch, etc. In such conditions, the result is either the gathering of yard materials with the pet waste or a failure to quickly separate and easily remove the waste from the yard.

Assuming a scraper is somewhat successful in gathering waste, it can be difficult to dislodge the gathered waste from the scraper in order to place the waste in a trash bag or other receptacle: either the waste is impacted onto the straight edge, or it is loose and has to be “pushed” by the scraper into a receptacle placed level with the ground. Alternatively, the waste can be balanced in the angle formed between the blade and the main body of the scraper head, resulting in the user performing the same “balancing act” required by the use of a rake.

Therefore, there is a need for an improved pet waste handling system that addresses the above limitations and problems.

### SUMMARY

Embodiments of the present invention described and claimed herein address the foregoing limitations and problems by providing an improved pet waste handling system. The present invention provides a gathering tool that can be used on a variety of yard surfaces, including grass, mulch, gravel, and concrete or other flat surfaces. The gathering tool is used with a bagging tool that supports a flexible bag in an open configuration to form a waste handling system that overcomes the problems associated with existing waste handling devices.

In one embodiment, a gathering tool comprises a gathering head affixed to the working end of a shaft. The opposite end of the shaft can have a handle or grip. The gathering head comprises a triangle-shaped, flat body having a number of fingers extending outwards from the base of the triangle. The apex of the triangular body is attached to the working end of the shaft. The handle can have a grip on the end opposite the working end. The body of the gathering head extends outwards from the shaft in a generally parallel orientation thereto. The distal end of the body and the associated fingers are angled or curved to form a somewhat concave shape. The fingers comprise an array of short, stiff tines. However, the fingers differ from conventional tines in that they are not sharply pointed but are instead rounded. The blunt ends of the fingers are similar in shape to a half-circle and are similar in size to the valleys between the fingers, causing the distal edge of the gathering tool to have a profile resembling a sine wave.

A bagging tool has a frame for supporting a flexible bag (e.g., a plastic grocery bag or small trash bag), and a retaining element for securing at least a portion of the flexible bag to the frame. The frame can have a shape that defines an opening through which the flexible bag extends. In one embodiment, the frame is generally triangle-shaped. A handle can be attached to apex of the frame. Opposite the apex is the base of the triangular frame. The base rests against the yard surface and holds the flexible bag in position to receive the pet wastes from the gathering tool. The shape of the frame can have at least one substantially straight side.

A pet waste handling system comprises both the gathering tool and the bagging tool wherein a user grasps one tool in one hand and the second tool in the other hand. The two are used in combination to gather waste or debris and deposit it in a bag this is then ready for disposal in a trash receptacle.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of a pet waste handling system.

FIG. 2 illustrates a perspective view of the front and side of an exemplary embodiment of a gathering head component of a pet waste handling system.

FIG. 3 illustrates a front view of an exemplary embodiment of a gathering head component of a pet waste handling system.

FIG. 4 illustrates a side view of an exemplary embodiment of a gathering head component of a pet waste handling system.

FIG. 5 illustrates a perspective view of the back and side of an exemplary embodiment of a bagging frame component of a pet waste handling system.

FIG. 6 illustrates a front view of an exemplary embodiment of a bagging frame component of a pet waste handling system.

FIG. 7 illustrates a side view of an exemplary embodiment of a bagging frame component of a pet waste handling system.

FIG. 8 illustrates a back view of an exemplary embodiment of a bagging frame component of a pet waste handling system.

### DETAILED DESCRIPTION

The present invention provides a gathering tool and a bagging tool which are used in combination to gather and deposit waste or pet debris into a bag which can then be easily and cleanly disposed of by a user. The system can quickly remove waste and debris from a variety of yard surfaces, including grass, mulch, gravel, and concrete or other flat surfaces. The gathering tool works to remove waste from the yard surface and gather it together. It can then be maneuvered into proximity with the bagging tool. The gathered wastes are deposited into a flexible bag that is supported in an open configuration by the bagging tool.

One advantage over current pet waste handling devices is that a user can operate both the gathering tool and the bagging tool at the same time. The user simply grasps one tool in one hand and the second tool in the other hand. The two are then used in combination to gather waste or debris and deposit it in a bag.

If the waste or debris is on a non-flat yard surface such as grass, gravel, mulch, etc., the user operates the system in a whisking mode. To whisk waste into the flexible bag, the user places the gathering tool on one side of the waste with the fingers pointing downwards and the bagging tool on the other side of the waste with the bag opening facing the waste or debris. The user then grasps the gathering tool using an overhand grip and guides the gathering head towards the bagging tool. The waste is separated from the grass (or other non-flat yard surface) by the action of the fingers and is gathered because of the concave shape of the head. As the user brings the gathering tool into contact with the bagging tool, the waste or debris is placed into the flexible bag and the system is ready to be used again. Alternatively, once the waste or debris has been deposited into the bag, the bag can be removed from the bagging tool and placed in a trash receptacle.

If, instead, the waste to be gathered is on a flat yard surface such as sidewalk, driveway, etc., the user operates the system in a scraping mode. To scrape waste or debris into the flexible bag, the user places the gathering tool on one side of the waste with the fingers resting on the yard surface and pointing parallel to the surface and away from the user. On the other side of the waste, the user places the bagging tool with the bag opening facing the waste. The user grasps the gathering tool using an underhand grip and guides the fingers under the waste. Because the total linear area of the leading edge of the tool is quite large (due to the rounded fingers, as opposed to a straight edge), the waste is easily scraped away from the yard surface and forced onto the head of the gathering tool. Because of the concave shape of the gathering head, the waste remains easily balanced on the tool until the user positions the bagging tool so that the gathering tool can be turned over and the waste or debris deposited into the flexible bag. If necessary, the user can tap the gathering tool fingers against the bottom of the flexible bag to dislodge any debris or waste. Because the bag is resting on the yard surface, the tapping motion imparts a reactive force that vibrates the gathering head and dislodges the waste. Furthermore, because the fingers are rounded, they do not puncture or damage the bag as would conventional rake tines. Once the waste or debris is placed into the flexible bag, the system is ready to be used again. Alternatively, the bag can be removed from the bagging tool and placed in a trash receptacle.

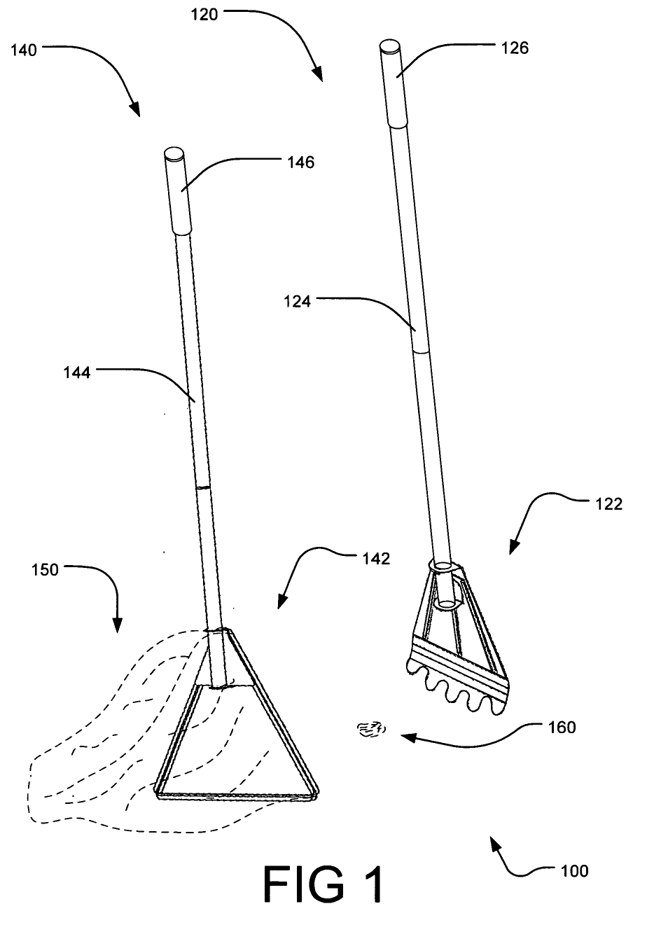

FIG. 1 illustrates a perspective view of an exemplary embodiment of a pet waste handling system 100. In one embodiment, a gathering tool 120 comprises a gathering head 122 affixed to the working end of a gathering shaft 124. The opposite end of the gathering shaft 124 can have a handle or grip 126. In one embodiment, the gathering tool head 122 and the gathering shaft 124 are fabricated from sheet metal such as eighteen gauge cold-rolled steel, although other suitably strong steel, plastic, wood, composite materials, etc. can be used. The gathering shaft can be adjustable in length. In the embodiment shown in FIG. 1, the gathering head 122 comprises a triangle-shaped, flat body having a number of fingers extending outwards from the base of the triangle. The apex of the triangular body is attached to the working end of the gathering shaft 124. The gathering shaft 124 can have multiple sections that attach to one another to form a single shaft. Such sections can attach via any method known or yet to be known in the art. In one embodiment, a spring-loaded button nub can extend outwards from a first shaft section near an end of that section, that section-end can fit inside a second shaft section, and the nub can pop up into a receiving hole in the second shaft section, effectively locking the two sections together. Other means of attaching and locking collapsible shaft sections together are contemplated. The gathering shaft 124 can have a grip 126 on the end opposite the working end.

In the embodiment shown in FIG. 1, a pet waste handling system 100 also comprises a bagging tool 140. The bagging tool 140 has a frame 142 for supporting a flexible bag 150 (e.g., a plastic grocery bag or small trash bag), and a retaining element for securing at least a portion of the flexible bag 150 to the frame 142. The frame 142 can have a shape that defines an opening through which the flexible bag 150 extends. In one embodiment, the frame 142 is generally triangle-shaped. A bagging shaft 144 can be attached to apex of the frame 142. The bagging shaft 144 can have multiple sections that attach to one another to form a single shaft. Such sections can attach via any method known or yet to be known in the art. The opposite end of the gathering shaft 124 can have a handle or grip 126. In one embodiment, the bagging tool frame 142 and the bagging shaft 144 are fabricated from sheet metal such as eighteen gauge cold-rolled steel, although other suitably strong steel, plastic, wood, composite materials, etc. can be used. The bagging shaft can be adjustable in length. In one embodiment, a spring-loaded button nub can extend outwards from a first shaft section near an end of that section, that section-end can fit inside a second shaft section, and the nub can pop up into a receiving hole in the second shaft section, effectively locking the two sections together. Other means of attaching and locking collapsible shaft sections together are contemplated.

Opposite the apex of the frame 142 is the base of the triangular frame 142. The base rests against the yard surface and holds the flexible bag 150 in position to receive the pet wastes 160 from the gathering tool 120. The shape of the frame 142 can have at least one substantially straight side.

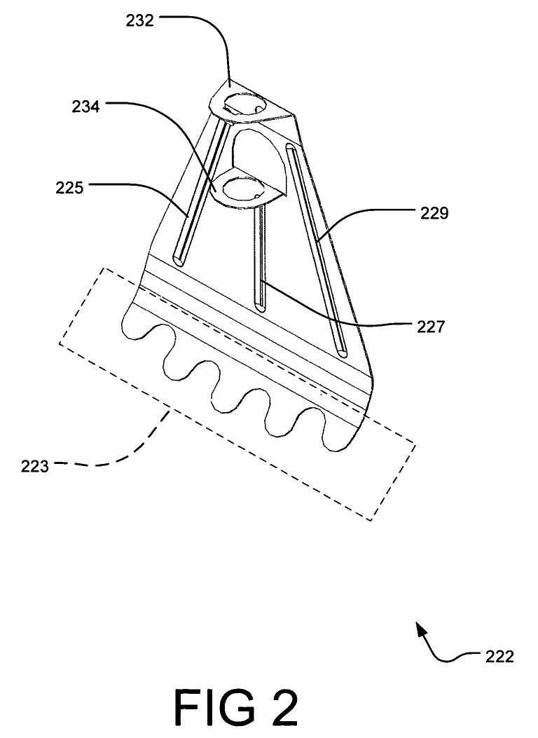

FIG. 2 illustrates a perspective view of the front and side of an exemplary embodiment of a gathering head component 222 of a pet waste handling system 100. The body of the gathering head 222 extends outwards from the gathering shaft 126 (not shown in FIG. 2, see FIG. 1) in a generally parallel orientation thereto. The distal end of the body and the associated fingers 223 are angled or curved to form a somewhat concave shape. The fingers 223 comprise an array of short, stiff tines. However, the fingers 223 differ from conventional tines in that they are not sharply pointed but are instead rounded. The blunt ends of the fingers 223 are similar in shape to a half-circle and are similar in size to the valleys between the fingers 223, causing the distal edge of the gathering tool 120 to have a profile resembling a sine wave. In the embodiment shown in FIG. 2, five fingers 223 are illustrated. In other embodiments, the number of fingers 223 can vary.

Also shown in FIG. 2 are three strengthening ribs 225, 227, and 229. The strengthening ribs 225, 227, and 229 can be attached to the gathering head 222, they can be stamped into the gathering head 222, or they can be formed in some other way as an integral part of the gathering head 222. Other configurations are contemplated. Furthermore, in other embodiments, zero or more strengthening ribs could be utilized. Strengthening ribs 225, 227, and 229 can be “v” shaped and be pressed into the back or front of the head 222.

Two other components shown in FIG. 2 are the top gathering shaft flange 232 and the bottom gathering shaft flange 234. The top flange 232 extends outwards from the main body of the gathering head 222. In the embodiment shown in FIG. 2, the top flange 232 extends roughly perpendicular to the gathering head 222. In other embodiments, the angle between the two can be significantly different. The gathering tool shaft 124 (not shown in FIG. 2, see FIG. 1) is positioned within the top flange 232 and the arrangement serves to assist in connecting the gathering head 222 to the shaft 124. In order to further strengthen that connection, a bottom flange 234 can also be employed. As shown in FIG. 2, the bottom flange 234 extends outwards from the main body of the gathering head 222. In the embodiment shown in FIG. 2, the bottom flange 234 extends roughly perpendicular to the gathering head 222. In other embodiments, the angle between the two can be significantly different. The gathering tool shaft 124 (not shown in FIG. 2, see FIG. 1) is positioned within the bottom flange 234 and the arrangement serves to assist in connecting the gathering head 222 to the shaft 124. In other embodiments, the gathering head 222 is affixed to the shaft 124 in other ways.

In the embodiment shown in FIG. 2, the flanges 232 and 234 extend outwards from the gathering head 222 on the same side of the gathering head 222 as the fingers 223. Alternatively, the flanges 232 and 234 could extend outwards from the other side of the gathering head 222.

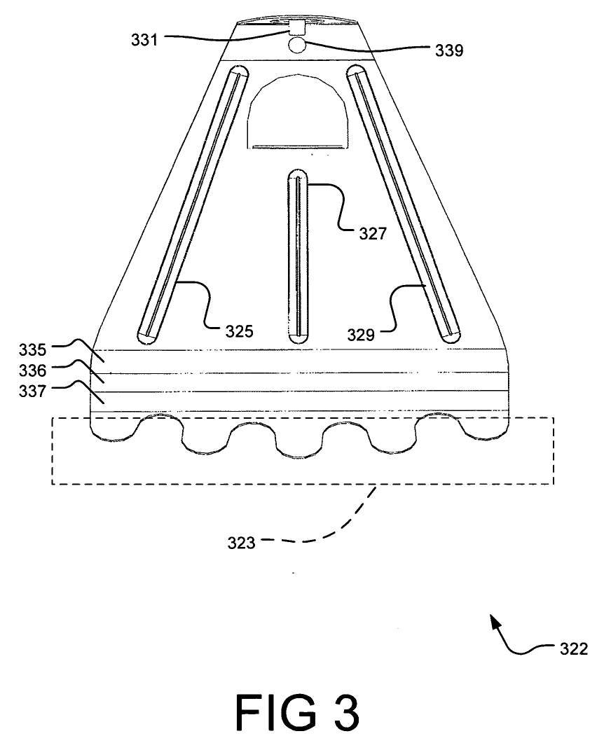

FIG. 3 illustrates a front view of an exemplary embodiment of a gathering head component 322 of a pet waste handling system 100. Components shown in FIG. 3 include a number of fingers 323; a first angled section 335; a second angled section 336; a third angled section 337; strengthening ribs 325, 327, and 329; a gathering support tab 331; and a gathering attachment mechanism 339.

The first angled section 335 is a section of the gathering head 322 that extends downwards and outwards from the main body of the gathering head 322 and in a different plane thereto. The angle between the first angled section 335 and the main body can vary depending on the embodiment, but is preferably within a range of zero to twenty-two and one half degrees. The second angled section 336, extends downwards and outwards from the first angled section 335 and in a different pane thereto. The angle between the second angled section 336 and the first angled section 335 can vary depending on the embodiment, but is preferably within a range of zero to twenty-two and one half degrees. The third angled section 337, extends downwards and outwards from the second angled section 336 and in a different pane thereto. The angle between the third angled section 337 and the second angled section 336 can vary depending on the embodiment, but is preferably within a range of zero to twenty-two and one half degrees. In alternate embodiments the number of angled sections can be more or less than three. In yet another embodiment, the angled sections are actually rounded sections or are a combination of angled and rounded sections.

Two other components shown in FIG. 3 are the support tab 331 and an attachment mechanism 339. The support tab 331 extends generally outwards and downwards from the top gathering shaft flange 232 and is therefore generally perpendicular to the plane containing the top gathering shaft flange 232. The support tab 331 contacts the gathering tool shaft 124 and helps align the shaft 124 and the gathering tool head 322 and assists in keeping the two properly affixed to each other.

The primary component responsible for affixing the gathering tool head 322 and the shaft 124 is the attachment mechanism 339. In the embodiment shown in FIG. 3, the attachment mechanism 339 comprises a spring-loaded nub extending out from the shaft 124 and a corresponding hole in the gathering tool head 322. As the shaft 124 is slid into the top gathering flange 232 and towards the bottom gathering flange 234, the spring-loaded nub becomes depressed. When properly aligned, the nub pops out and extends into the corresponding hole on the gathering tool head 322. As illustrated in FIG. 3, only the corresponding hole is shown and labeled as the attachment mechanism 339. In other embodiments, other means of attaching the gathering head 322 to the shaft 124 are contemplated.

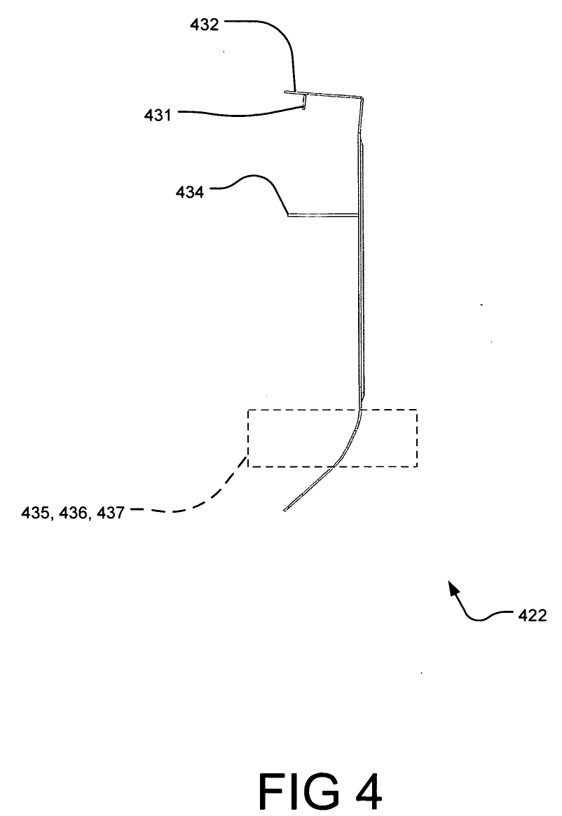

FIG. 4 illustrates a side view of an exemplary embodiment of a gathering head component of a pet waste handling system 100. In this view, it is easier to see the shape imparted by the first angled section 435, the second angled section 436, and the third angled section 437. As mentioned above, more or fewer angled sections could be used in alternate embodiments. Furthermore, the angles between the angled sections, and between the angled sections and other components, can vary in other embodiments as well.

The support tab 431 extends generally outwards and downwards from the top gathering shaft flange 432 towards the bottom gathering shaft flange 434. The support tab 431 is therefore generally perpendicular to the plane containing the top gathering shaft flange 432. The support tab 431 contacts the gathering tool shaft 124 and helps align the shaft 124 and the gathering tool head 422 and assists in keeping the two properly affixed to each other.

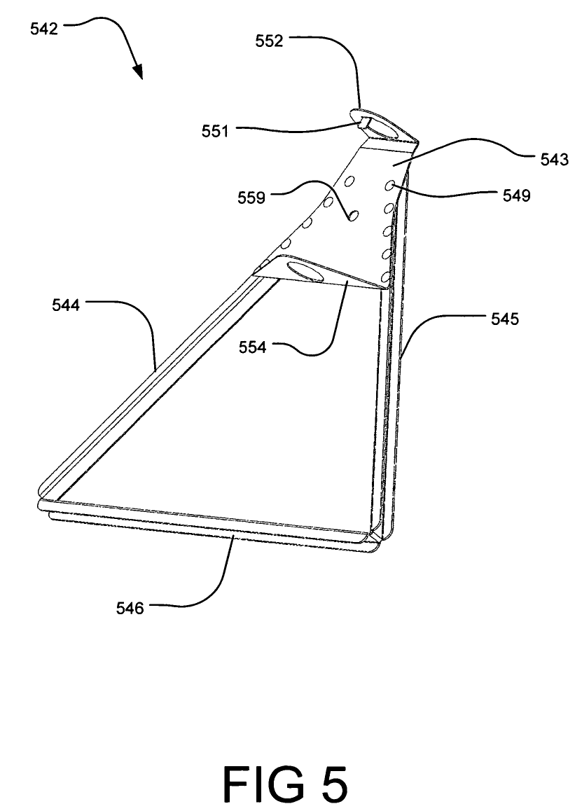

FIG. 5 illustrates a perspective view of the back and side of an exemplary embodiment of a bagging frame component 542 of a pet waste handling system 100. The frame 542 comprises a yoke 543, a first support member 544, a second support member 545, and a base member 546. The members 544, 545, and 546 can be “C-channel” shaped so that they have an interior space for securely holding an elastic band retaining member (not shown in FIG. 5).

In one embodiment, the frame 542 is fabricated from sheet metal such as eighteen gauge cold-rolled steel, although other suitably strong steel, plastic, or composite materials can be used. Each member 544, 545, and 546 of the frame 542 can be joined end-to-end to each other member to form a substantially equilateral triangle. Alternatively, the frame 542 can be constructed of a single supporting member bent in two places and joined together at the ends. The length of each member 544, 545, and 546 is carefully chosen to provide a perimeter that fits commonly used bags (such as small trash bags or plastic shopping bags commonly used in grocery stores). In an embodiment sized to fit a bag of a particular capacity, such as a grocery bag, larger bags can be easily accommodated by gathering the open end of the larger bag, draping it over the frame 542, into pleats or otherwise, and securing the open end of the bag to the frame 542 with an elastic retainer, large rubber band, etc.

Attachment points 549 can be rivets, welds, etc. Two other components shown in FIG. 5 are the gathering support tab 551 and a bagging attachment mechanism 559. The bagging support tab 551 extends generally outwards and downwards from the top bagging shaft flange 552 and is therefore generally perpendicular to the plane containing the top bagging shaft flange 552. The support tab 551 contacts the bagging tool shaft 144 and helps align the shaft 144 and the bagging tool head 542 and assists in keeping the two properly affixed to each other.

The primary component responsible for affixing the bagging tool head 542 and the shaft 144 is the attachment mechanism 559. In the embodiment shown in FIG. 5, the attachment mechanism 559 comprises a spring-loaded nub extending out from the shaft 144 (not shown) and a corresponding hole 559 in the bagging tool head 542. As the shaft 144 is slid into the top bagging flange 552 and towards the bottom bagging flange 554, the spring-loaded nub becomes depressed. When properly aligned, the nub pops out and extends into the corresponding hole 559 on the bagging tool head 542. As illustrated in FIG. 5, only the corresponding hole 559 is shown as the attachment mechanism 559. In other embodiments, other means of attaching the bagging head 542 to the shaft 144 are contemplated.

In some embodiments, the yoke 543 can be coupled to one corner of the frame 542. The yoke 543 can be a generally triangular plate coupled to two adjacent members 544, 545, and 546. The yoke 543 serves as the connection point between the bagging tool shaft 144 and the frame 542.

As mentioned above, the members 544, 545, and 546 can be formed as channels having opposing flanges for capturing and securing an elastic retainer therebetween. A small cutout (not shown) can be made in one flange of the frame 542 to assist in removing the elastic retainer.

In other embodiments of the present invention, the frame 542 can define other shapes besides a triangle, such as a square, pentagon, hexagon, circle, oval, or an irregular shape. A frame formed in any of the aforementioned shapes can be provided with retaining surfaces for capturing and securing a bag-clamping element, such as the elastic retainer described above.

Installation of a plastic grocery-type bag to the bagging tool 140 is accomplished by passing the open end of the bag 150 through the back of the frame 542, draping and folding the top, open end of the bag 150 over the frame 542, and securing the bag 150 to the frame 542 by placing an elastic retainer in the c-channel in the members 544, 545, and 546 of the frame 542. The elastic retainer securely holds the folded-over top of the open end of the bag 150 in the c-channel. With the bag 150 securely retained against the frame 542, the bagging tool 140 can be used to collect multiple pet wastes or debris before the bag 150 is full and needs to be replaced. In another embodiment, multiple bags 150 are pre-loaded onto the bagging tool 140 so that when one is full it is removed and placed in a garbage receptacle, and a fresh one is already in place and ready to be used.

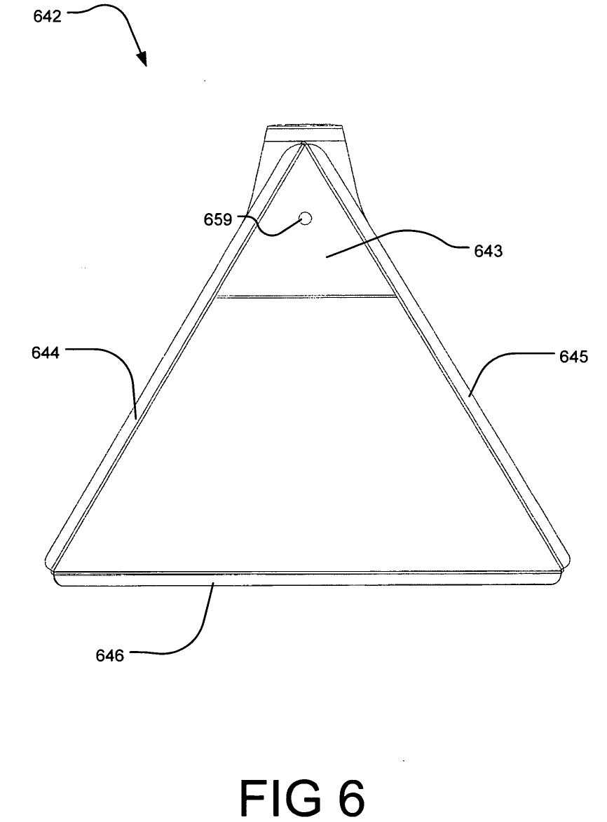

FIG. 6 illustrates a front view of an exemplary embodiment of a bagging frame component 642 of a pet waste handling system 100. The frame 642 comprises a yoke 643, a first support member 644, a second support member 645, and a base member 646. The members 644, 645, and 646 can be “C-channel” shaped so that they have an interior space for securely holding an elastic band retaining member (not shown in FIG. 6). Also illustrated in FIG. 6 is the bagging attachment mechanism 659. As discussed above, the bagging attachment mechanism hole 659 shown in FIG. 6 is just one portion of the means of attaching the shaft 144 to the frame 642. The hole 659 receives the nub from the shaft 144 and helps to lock the shaft 144 to the frame 642.

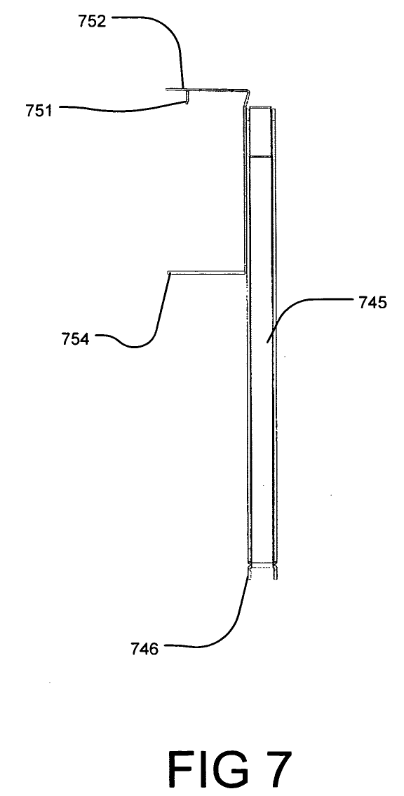

FIG. 7 illustrates a side view of an exemplary embodiment of a bagging frame component 742 of a pet waste handling system 100. In this view it is easier to see the “c-channel” shape of the members 745 and 746.

The bagging support tab 751 extends generally outwards and downwards from the top bagging shaft flange 752 towards the bottom bagging shaft flange 754. The support tab 751 is therefore generally perpendicular to the plane containing the top bagging shaft flange 752. The support tab 751 contacts the bagging tool shaft 144 and helps align the shaft 144 and the bagging tool frame 742 and assists in keeping the two properly affixed to each other.

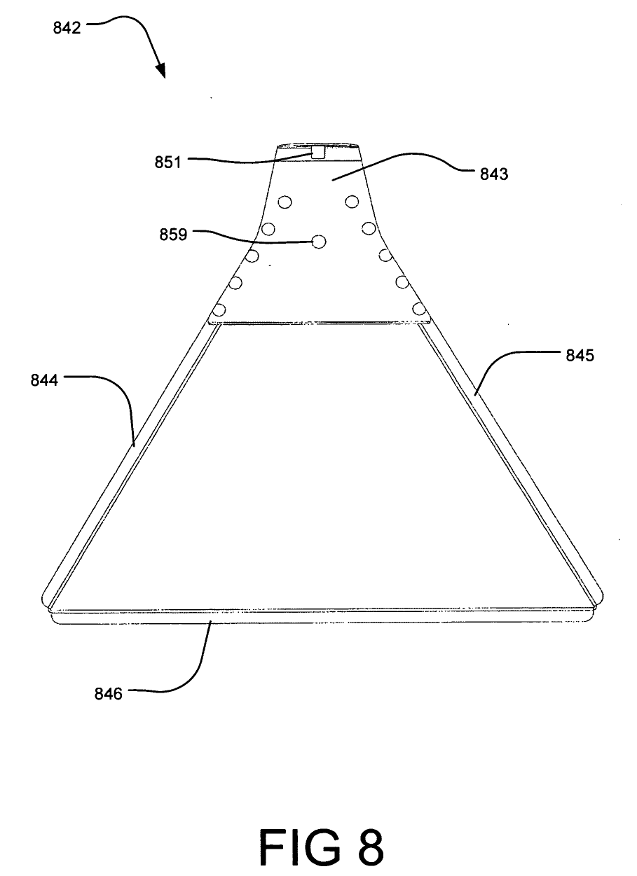

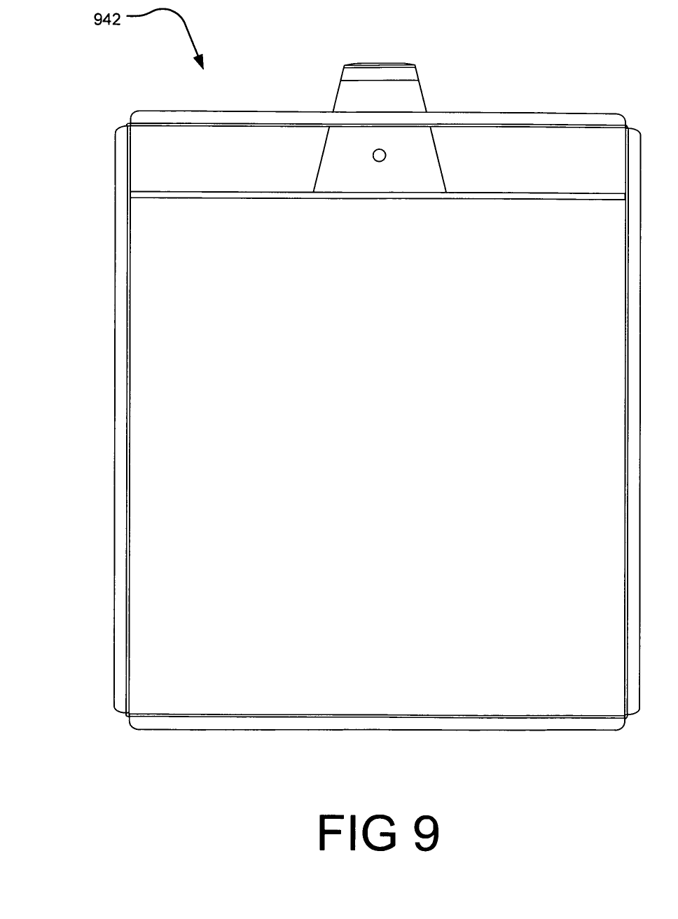

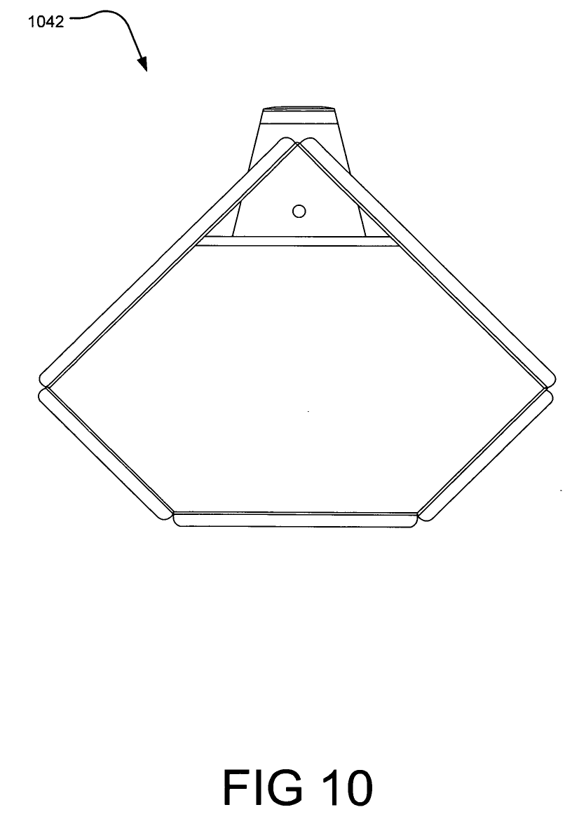

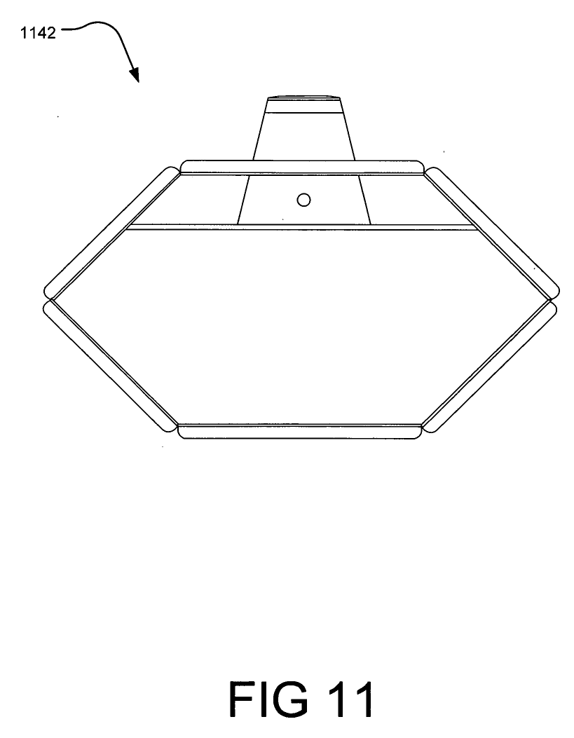

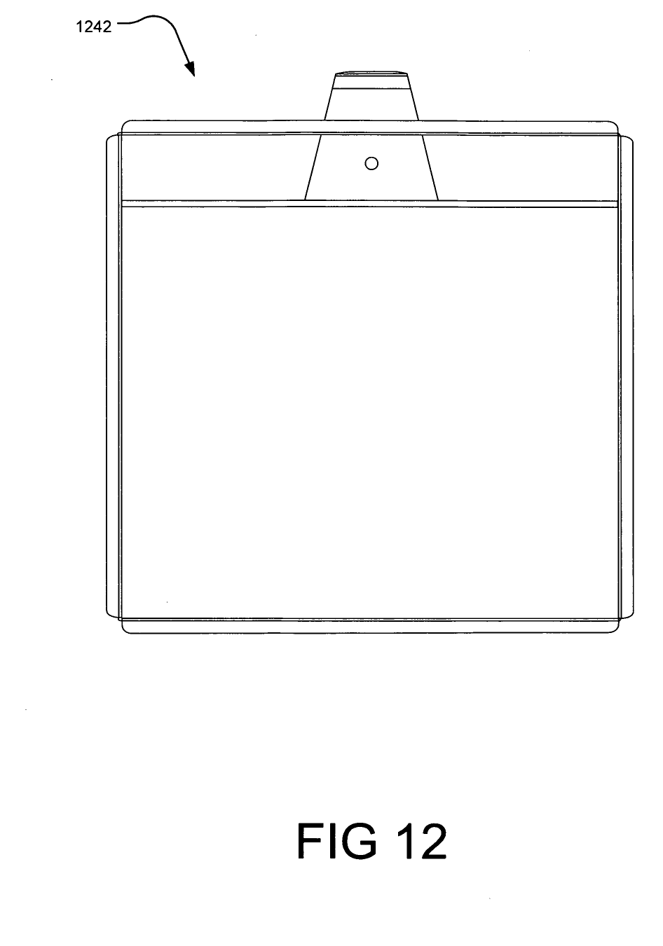

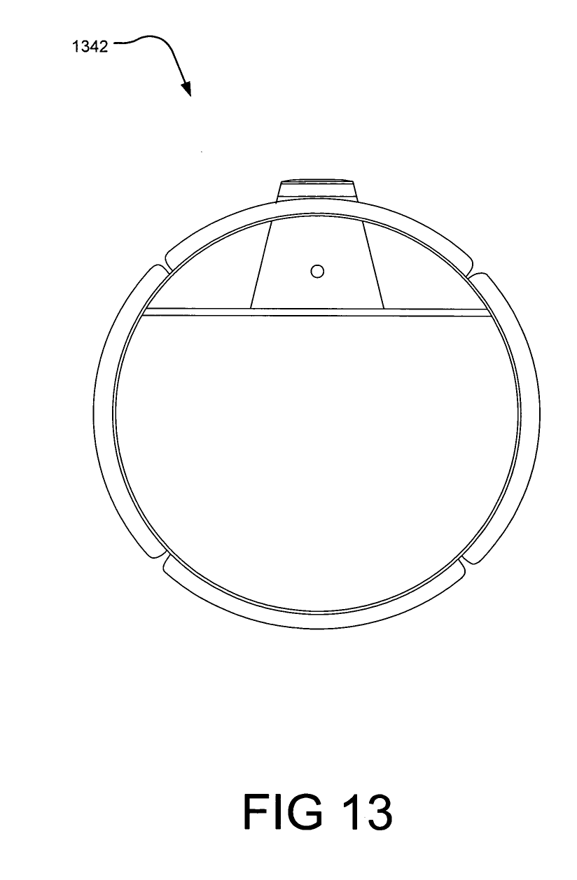

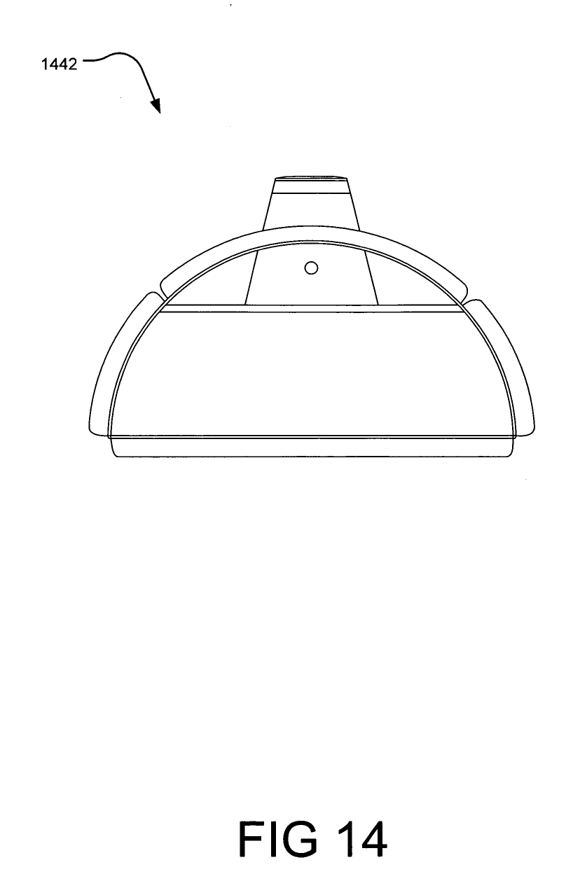

FIG. 8 illustrates a back view of an exemplary embodiment of a bagging frame component 842 of a pet waste handling system 100. The frame 842 comprises a yoke 843, a first support member 844, a second support member 845, and a base member 846. The members 844, 845, and 846 can be “C-channel” shaped so that they have an interior space for securely holding an elastic band retaining member (not shown in FIG. 8). Also illustrated in FIG. 8 is the bagging attachment mechanism 859. As discussed above, the bagging attachment mechanism hole 859 shown in FIG. 8 is just one portion of the means of attaching the shaft 144 to the frame 842. The hole 859 receives the nub from the shaft 144 and helps to lock the shaft 144 to the frame 842. The bagging support tab 851 is also shown.

The above specification, examples and data provide a description of the structure and use of exemplary embodiments of the described articles of manufacture and methods. Many embodiments can be made without departing from the spirit and scope of the invention.

What is claimed is:

1. A pet waste handling system, comprising:
a gathering tool having a gathering shaft and a gathering head with a main body;
the main body having a plurality of relatively stiff fingers angling away from the gathering head and wherein the plurality of fingers have a generally rounded or half-circular shape; and
wherein the gathering tool is configured to be used to both whisk debris into a receiving receptacle and to scrape debris into the receiving receptacle.

2. The pet waste handling system of claim 1, wherein the gathering shaft is removably attached to the gathering head.

3. The pet waste handling system of claim 2, wherein the main body is generally triangular in shape, having the gathering shaft attached to the apex of the triangular shape and the plurality of fingers extending from the base of the triangular shape.

4. The pet waste handling system of claim 1, wherein the receiving receptacle further comprises:
a bagging tool having a frame and a bagging shaft;
the frame defining an opening for receiving an open end of a bag and having a channel for receiving an elastic retaining device around a perimeter of the frame;
the elastic retaining device having an unstretched circumference smaller than the perimeter of the frame and configured to be secured around at least a portion of the perimeter separately from the bag and over at least a portion of the bag at least partially surrounding the perimeter; and
one or more retaining surfaces extending from the frame and configured to retain the length of the elastic retaining device about the frame and portion of the bag.

5. The pet waste handling system of claim 2, wherein the receiving receptacle further comprises:
a bagging tool having a frame and a bagging shaft;
the frame defining an opening for receiving an open end of a bag and having a channel for receiving an elastic retaining device around a perimeter of the frame;
the elastic retaining device having an unstretched circumference smaller than the perimeter of the frame and configured to be secured around at least a portion of the perimeter separately from the bag and over at least a portion of the bag at least partially surrounding the perimeter; and
one or more retaining surfaces extending from the frame and configured to retain the length of the elastic retaining device about the frame and portion of the bag.

6. The pet waste handling system of claim 3, wherein the receiving receptacle further comprises:
a bagging tool having a frame and a bagging shaft;
the frame defining an opening for receiving an open end of a bag and having a channel for receiving an elastic retaining device around a perimeter of the frame;
the elastic retaining device having an unstretched circumference smaller than the perimeter of the frame and configured to be secured around at least a portion of the perimeter separately from the bag and over at least a portion of the bag at least partially surrounding the perimeter; and
one or more retaining surfaces extending from the frame and configured to retain the length of the elastic retaining device about the frame and portion of the bag.

7. The pet waste handling system of claim 4, wherein a cross-section of at least a portion of the frame is generally U-shaped, C-shaped, V-shaped, or concave.

8. The pet waste handling system of claim 5, wherein a cross-section of at least a portion of the frame is generally U-shaped, C-shaped, V-shaped, or concave.

9. The pet waste handling system of claim 6, wherein a cross-section of at least a portion of the frame is generally U-shaped, C-shaped, V-shaped, or concave.

10. The pet waste handling system of claim 7, wherein the opening formed by the frame has a shape selected from the group consisting of a triangle, a quadrilateral, a pentagon, and a hexagon.

11. The pet waste handling system of claim 8, wherein the opening formed by the frame has a shape selected from the group consisting of a triangle, a quadrilateral, a pentagon, and a hexagon.

12. The pet waste handling system of claim 9, wherein the opening formed by the frame has a shape selected from the group consisting of a circle, a triangle, a square, a quadrilateral, a pentagon, and a hexagon.
